(19) United States
(12) Patent Application Publication
(10) Pub. No.: US 2022/0135368 A1
(43) Pub. Date: May 5, 2022

(54) BRAKE SYSTEM AND A METHOD FOR AN ELEVATOR AND AN ELEVATOR

(71) Applicant: Kone Corporation, Helsinki (FI)

(72) Inventors: Juha HELENIUS, Helsinki (FI); Raimo PELTO-HUIKKO, Helsinki (FI)

(73) Assignee: Kone Corporation, Helsinki (FI)

(21) Appl. No.: 17/503,782

(22) Filed: Oct. 18, 2021

(30) Foreign Application Priority Data
Nov. 3, 2020 (EP) 20205409.4

(51) Int. Cl. B66B 1/32

(52) U.S. Cl. CPC B66B 1/32; B66B 1/365

(57) ABSTRACT

A brake system and method for elevators, the elevator comprising an elevator car and suspension means supporting the elevator car and the counterweight. The brake system comprises at least one brake configured to decelerate the elevator car, means for measuring elevator deceleration configured to produce feedback, such as a displacement, relating to elevator deceleration to the at least one brake, and means for adjusting brake force and/or torque based on the feedback from the means for measuring elevator deceleration. The means for adjusting brake force and/or torque is configured to control the brakes to produce a variable brake force and/or torque so that the elevator car deceleration is kept essentially constant at a predefined set point value or within a certain range around the predefined set point value.

### RELATED APPLICATIONS

This application claims priority to European Patent Application No. 20205409.4 filed on Nov. 3, 2020, the entire contents of which are incorporated herein by reference.

### TECHNICAL FIELD

The invention relates to a brake system for an elevator, a method for a brake system for an elevator and an elevator.

### BACKGROUND

High friction suspension means are becoming more common in elevators due to their technical and economic benefits such as lightweight and cost efficient hoisting function, long lifetime, small D/d ratio (low torque requirement for machine and brake, space efficiency) and freedom from maintenance. Although high friction suspension means create benefits, they also may require changes to the other parts of the elevator system.

One of the problems with high friction suspension means relates to high friction between suspension means and traction sheave which causes problems in machine brake torque dimensioning. Elevator standards, such as EN81-20, define requirements for elevator brake system, which determine the minimum brake torque. Since the minimum brake torque is relatively high and high friction ropes do not slip on the traction sheave, the elevator stops very rapidly in emergency stop with certain car load and driving direction. Elevator standards also set 1 G as the highest allowed deceleration. A deceleration higher than this may cause passengers to fall in the car and get injured. To limit the car deceleration, a maximum value for the brake torque can also be calculated. However, the maximum brake torque is often just slightly larger or even smaller than the minimum torque. This means that the brake torque dimensioning window is narrow or even nonexistent. If the window is non-existent, the minimum torque determines brake dimensioning.

Typically, the highest emergency stop deceleration occurs when empty (or almost empty) car is travelling downwards or full car is travelling upwards, because in these cases also gravitation decelerates the system. If car is empty (or almost empty) the system also has the least moving mass. With conventional steel wire ropes the maximum allowed deceleration is virtually never exceeded, because these ropes slip on the traction sheave and rope slip limits the deceleration. However, with high friction suspension means the slip does not occur. The higher is the rated load of the elevator relative to the moving masses of the system, the narrower is the brake torque window. As new lightweight hoisting systems are developed, the situation is becoming more challenging. Also, elevators with double wrap arrangement may have the problem.

For these reasons there is a need for improved solutions for a brake system for an elevator with which the drawbacks of the prior art systems can be avoided.

### SUMMARY

An object of the invention is to present a brake system capable of producing a variable brake force so that car deceleration is constant or within a specified range regardless of load or driving direction.

According to a first aspect, the invention relates to a brake system for elevators, the elevator comprising an elevator car and suspension means supporting the elevator car and the counterweight. The brake system comprises at least one brake configured to decelerate the elevator car, means for measuring elevator deceleration configured to produce feedback, such as a displacement, relating to elevator deceleration to the at least one brake, and means for adjusting brake torque based on the feedback from the means for measuring elevator deceleration. The means for adjusting brake torque is configured to control the brakes to produce a variable brake torque so that the elevator car deceleration is kept essentially constant at a predefined set point value or within a certain range around the predefined set point value.

In one embodiment of the invention the means for adjusting brake torque is a mechanical and/or hydraulic controller configured to control the brakes of the brake system, e.g. a proportional controller. The proportional controller can be implemented with mechanical and/or hydraulic means and so that the brake adjusting or opening force is proportional to elevator deceleration. In one embodiment of the invention also electronic control unit can be arranged to control the brake adjustment, e.g. to receive deceleration information and to adjust the brakes according to the predefined set point value.

In one embodiment of the invention the means for measuring elevator deceleration is configured to measure the deceleration based on inertial force caused by an inertial mass, wherein the inertial mass is connected to moving components of the elevator so that the inertial force is proportional to elevator deceleration, and wherein the inertial force is configured to be converted to a displacement and the displacement corresponds with the elevator deceleration or the inertial force is configured to be converted directly to feedback e.g. with a force sensor.

In one embodiment of the invention means for measuring elevator deceleration is configured to measure deceleration from hoisting rope termination support spring displacement caused by one or more rope forces on the rope termination fixing on the counterweight side of the sheave.

In one embodiment of the invention means for measuring elevator deceleration comprises a diverter pulley which is allowed to be displaced in such a way that during normal elevator operation the pulley is in the first position/rests on a fixed support but if rope force changes more than a predefined threshold value, a displacement is caused to the pulley from the first position that is proportional to rope force, the diverter pulley being arranged e.g. in connection to the hoisting ropes on the counterweight side of the sheave.

In one embodiment of the invention the means for measuring elevator deceleration comprise an inertia wheel operatively coupled with a moving component of the elevator (and optionally concentric with it), such as a traction sheave, and wherein feedback relating to elevator deceleration is the inertia of the inertia wheel, and the means for measuring elevator deceleration is configured such that the inertia is converted to measurable spring displacement.

In one embodiment of the invention means for measuring elevator deceleration is an acceleration sensor.

In one embodiment of the invention a force for adjusting the brake torque is transmitted to the brake mechanically based on the displacement, and/or wherein the force for adjusting the brake torque is configured to be taken from the spring that is used in the means for measuring elevator deceleration, e.g. from rope termination support spring or diverter pulley support spring.

In one embodiment of the invention a force for adjusting the brake torque is transmitted to the brake hydraulically based on the displacement, and/or wherein the force for adjusting the brake torque is configured to be created with a hydraulic system and controlled by decelerometer spring movement and hydraulic valves.

In one embodiment of the invention the predefined deceleration setpoint value, P-term of the proportional controller and/or response time of the controller are dependent on at least one of the following parameters: inertial mass, spring stiffness, rope termination or diverter pulley mass, piston areas, dimensions of the levers, presence of a damper configured to stabilize the controller, clearances, hydraulic valve properties.

In one embodiment of the invention the brake system is essentially or fully mechanical and/or hydraulic.

In one embodiment of the invention the suspension means are high friction suspension means such as toothed belts, ropes or belts comprising polymer coating, e.g. TPU, and/or ropes or belts comprising high friction lubricants.

In one embodiment of the invention the brake is a machinery brake or a car brake of the elevator.

According to a second aspect, the invention relates to a method for braking an elevator with a brake system, the elevator comprising an elevator car and suspension means supporting the elevator car and the counterweight. The brake system comprises at least one brake configured to decelerate the elevator car, means for measuring elevator deceleration configured to produce feedback, such as a displacement, relating to elevator deceleration to the at least one brake, and means for adjusting brake torque based on the feedback from the means for measuring elevator deceleration. In the method the deceleration of the elevator car is measured with means for measuring elevator deceleration, the deceleration is compared to a predefined setpoint value, and brake torque is controlled according to the difference between measured deceleration and the predefined set point value with the means for adjusting brake torque.

According to a third aspect, the invention relates to an elevator comprising an elevator car, an elevator motor configured to move the elevator car, and a brake system arrangement according to the solution of the invention.

According to a fourth aspect, the invention relates to computer program comprising instructions which, when executed by a computer, cause the computer to carry out the method according to invention.

According to a fifth aspect, the invention relates to computer-readable medium comprising the computer program according to invention.

With the solution of the invention, several benefits over the prior art solutions can be achieved. With the brake system of the invention deceleration can be adjusted to desired and safe value, which improves passenger safety. The solution of the invention solves also brake torque dimensioning problem related to the solutions of the prior art.

With the brake system of the invention the brake torque fluctuates rapidly due to dynamic properties of the system. In one embodiment of the invention the fluctuation can be reduced by adding a damper in the controller. The brake system of the invention also reduces car vibration after the system has stopped, since less strain energy is stored in the ropes during emergency stop due to smaller deceleration.

Further benefits can be achieved with the brake system of the invention, e.g. the solution of the invention widens brake application range because a brake engineered for a large rated load can also be used in smaller elevators.

Also, one further benefit of the invention is that if the elevator can be decelerated in a controlled manner, the counterweight of the elevator will not jump. Counterweight jumping is a problem in an uncompensated elevator e.g. when decelerating an empty car because a large braking force stops the empty car quickly and the counterweight continues its upward movement. This jump of the counterweight may lead into the following problems: impact on load-bearing structures such as counterweight frames, ropes and rope clamps when the counterweight drops back onto the ropes. Also, loose ropes can cause damage. This all can be avoided with the solution of the invention.

Still another advantage can be achieved with the solution of the invention in a situation where coated ropes are used. In that kind of elevator system, the slipping of the coated ropes can be avoided if the deceleration is kept in the desired range. By avoiding slipping of the ropes, it's possible to better predict the friction between the ropes and the traction sheave, especially in the case of coated ropes. Thus, the elevator system can be dimensioned more reliably when there is no slipping between the ropes and traction sheave during braking. The deceleration can be limited e.g. in such a way that the friction factor demand between the ropes and the traction sheave does not increase to such an extent that the ropes begin to slip significantly on the traction sheave.

The brake system of the present invention can be implemented fully mechanically or hydraulically so that it works also in case of a power cut of the electricity network.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

The embodiments of the invention are illustrated by way of example, and not by way of limitation, in the figures of the accompanying drawings, in which:

FIG. 1 illustrates a simplified elevator according to one embodiment of the invention,

FIG. 2A illustrates a simplified elevator according to one embodiment of the invention,

FIG. 2B illustrates a simplified elevator according to one embodiment of the invention,

FIG. 3A illustrates a brake system according to one example embodiment of the invention,

FIG. 3B illustrates a brake system according to one example embodiment of the invention,

FIG. 3C illustrates a brake system according to one example embodiment of the invention,

FIG. 3D illustrates a brake system according to one example embodiment of the invention,

FIG. 3E illustrates a brake system according to one example embodiment of the invention,

FIG. 3F illustrates a brake system according to one example embodiment of the invention,

FIG. 3G illustrates a brake system according to one example embodiment of the invention,

FIG. 3H illustrates a brake system according to one example embodiment of the invention,

FIG. 4 illustrates a part of the brake system according to one example embodiment of the invention,

FIG. 5 illustrates as a sample graph, how the brake force can be adjusted, and

FIG. 6 presents a flow chart illustrating a method according to one embodiment of the invention.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

Reference will now be made in detail to the embodiments of the present invention, examples of which are illustrated in the accompanying drawings.

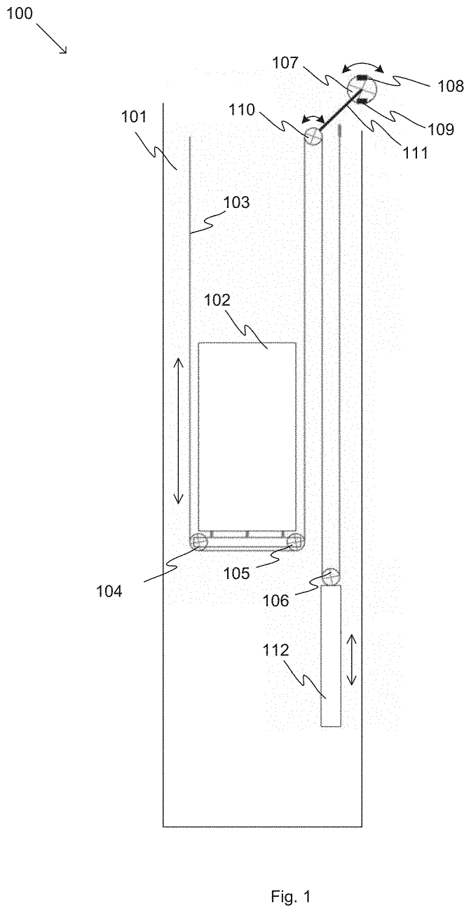

FIG. 1 illustrates an elevator system 100 according to one example embodiment of the invention. The elevator system comprises an elevator shaft 101 in which an elevator car 102 moves to serve different floors. In FIG. 1 only one type of elevator system is illustrated and described but the solution of the invention can be used for different kinds of elevators than what is described relating to FIG. 1. Although FIG. 1 illustrates only one elevator shaft 101, there may be more than one elevator shaft in the elevator system. In the elevator system, there can be one side towards which landing doors at each floor can be opened. In another embodiment it is possible that the elevator car has doors towards more than one side of the elevator car 102.

The elevator car 102 is configured to perform a travel in the elevator shaft 101, wherein the elevator car is moved in this example by a motor via the traction sheave 110 with suspension means 103 such as hoisting ropes. The term “travel” may refer to a process where the elevator car 102 may be configured to move in the elevator shaft 101 according to instructions from an elevator controller configured to control the movement of the elevator, and e.g. the motor. The elevator may also comprise a counterweight 112.

The example elevator embodiment of FIG. 1 is two to one (2:1) roping-ratio type elevator. In this type of an elevator hoisting ropes 103 are arranged such that one end of each hoisting rope passes from a dead end hitch in the overhead, down and via deflection pulleys 104, 105 under the car, up over the hoist machine traction sheave, then down and around a counterweight deflection pulley 106, and, finally, up to another dead end hitch in the overhead.

The elevator comprises a brake able to decelerate and stop the elevator car. The brake which can be used in the solution of the invention can be for example, a machinery brake or a safety gear or a car brake (if it is used dynamically, for decelerating the car). In the example of FIG. 1 the brake comprises brake wheel 107 and brake pads 108, 109. The brake wheel 107 can be connected to traction sheave for example by a shaft 111.

As stated above, the principle described in this application can also be applied to safety gear. In this case the deceleration caused by the activated safety gear can be limited in the corresponding manner as is described relating to the elevator brake, e.g. by limiting the friction force against the guide rails.

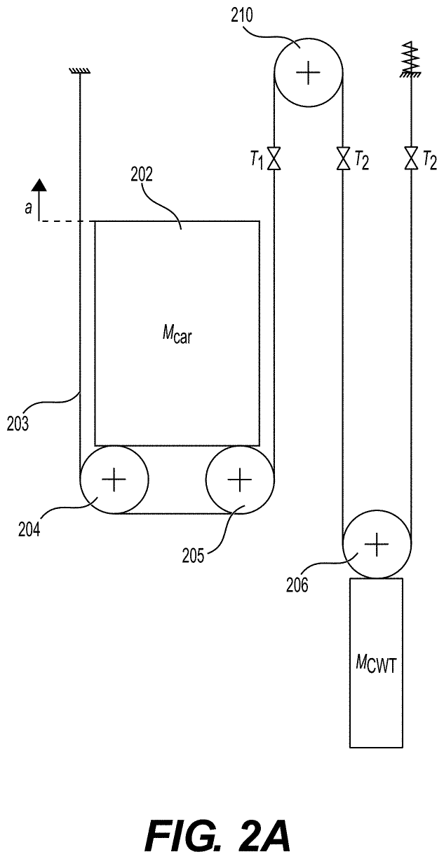

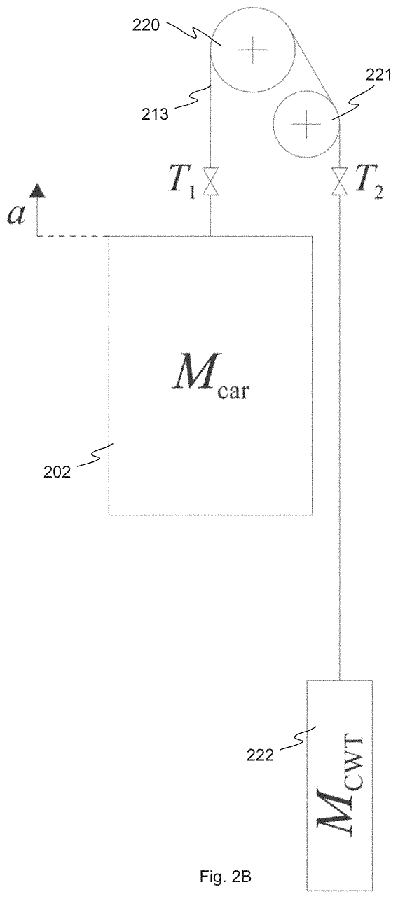

A two to one (2:1) roping-ratio type elevator is also presented in FIG. 2A as a more simplified illustration. As in FIG. 1 the hoisting ropes 203 are arranged such that one end of each hoisting rope passes from a dead end hitch in the overhead, down and via deflection pulleys 204, 205 under the car, up over the hoist machine traction sheave, then down and around a counterweight deflection pulley 206, and, finally, up to another dead end hitch in the overhead.

The brake system of the invention can also be used for elevators with 1:1 roping ratio. FIG. 2B presents a simplified illustration of this kind of an elevator. For 1:1 roping, the rope 213 is arranged to travel via traction sheave 220 such that one end of the hoisting rope is fastened to the car 202, it runs over the traction sheave 220 and the other end is fastened to the counterweight 222. A diverter pulley 221 can be arranged to direct hoisting ropes to the car or counterweight in an optimal manner.

In the embodiments of FIGS. 2A and 2B and in also in the other figures forces caused by the moving masses are represented. In the mentioned figures T₁ represents the tension in the hoisting rope on the car side of traction sheave 210 and T₂ the tension in the hoisting rope on the counterweight side.

The suspension means used in the solution of the invention, such as ropes or belts, can be high friction suspension means. High friction can be achieved by applying polymer coating, e.g. TPU, on the load bearing members of the suspension means. Other solutions which are used to implement high friction suspension means are toothed belt and/or high friction lubricants.

The solution of the present invention can be used e.g. in the emergency braking of the elevator. Also, in this situation it is important that passenger comfort and safety is ensured. Thus, there are minimum and maximum values for deceleration. Typically, the highest emergency stop deceleration occurs when empty (or almost empty) car is travelling downwards or full car is travelling upwards, because in these cases also gravitation decelerates the system. If car is empty (or almost empty) the system also has the least moving mass, i.e. the least inertia. Elevator standards set 1 G as the highest allowed deceleration. It may be advantageous to limit the deceleration to lower levels than 1 G for better passenger safety and according to one embodiment the deceleration limit is approximately 5 m/s².

In the solution of the present invention the brake system comprises means for measuring elevator deceleration configured to produce feedback, such as a displacement, relating to elevator deceleration to the at least one brake, and means for adjusting brake torque based on the feedback from the means for measuring elevator deceleration. The means for adjusting brake torque is configured to control the brakes to produce a variable brake torque so that the elevator car deceleration is kept essentially constant at a predefined set point value or within a certain range around or under the predefined set point value. This way passenger comfort and safety can be ensured.

In one embodiment of the invention the elevator brake can be dimensioned to be able to provide the required deceleration in all situations and/or to keep the car level during loading. The braking torque and deceleration is thus in principle large enough for even the most demanding situations. In this case the brake force can then be reduced with the solution of the invention in order to achieve the desired deceleration rate. This kind of solution has the advantage that if the deceleration adjustment mechanism is not operational for some reason, full brake force is still used, and the car is stopped despite of a malfunction.

The brake system of the invention can comprise a mechanical or hydraulic controller, such as proportional controller (P-controller) for elevator deceleration. It can measure the deceleration, compare the deceleration to the desired value (set point) and control brake torque according to the difference between measured deceleration and set point. For example, if the deceleration is too high, brake torque can be reduced until the deceleration has settled to the desired value.

The means for measuring elevator deceleration can be based on inertial force caused by an inertial mass. The mass is connected to moving components of the elevator so that the inertial force is proportional to elevator deceleration. The inertial force can be then converted to corresponding feedback, e.g. displacement, using for example a spring, and this feedback, e.g. displacement, works as the means to measure the deceleration of the elevator car.

There are several methods to implement the means to measure the deceleration of the elevator car. In one embodiment deceleration can be measured from rope termination support spring displacement, because rope forces are directly proportional to elevator acceleration. This type of measurement can be implemented for example to the rope termination fixing on the counterweight side of the sheave, since the counterweight mass is constant unlike car mass which is dependent on load. In this case the counterweight can itself work as the inertial mass. With 2:1 suspension type arrangement of the elevator the rope termination fixings are located close to the machine either in the machine room or at the top of the shaft, which makes the feedback route to brake opening mechanism short and uncomplicated. The means for measuring elevator deceleration can utilize one or more rope forces. In FIG. 2A, the single line 203 represents one or more parallel hoisting ropes. In one embodiment at least two rope forces should be utilized since individual rope forces can be different. In one embodiment of the invention the means to measure the deceleration of the elevator car utilizes the total force of all ropes.

In one embodiment of the invention the means to measure the deceleration of the elevator car can be implemented using a diverter pulley which is allowed to be displaced. For example, the pulley can be mechanically supported, and a pre-loaded spring can be attached to the pulley fixing. During normal elevator operation the pulley can be in first position, e.g. rest on a fixed support. However, if rope force changes enough, the spring causes pulley displacement from the first position, wherein the displacement is proportional to rope force. The diverter pulley can be e.g. on counterweight side so that the inertial mass is constant. This type of solution is applicable for example with 2:1 and 1:1 type of suspension arrangement of the elevator. In one embodiment of the invention the diverter pulley can be lightweight to shorten the response time of the means to measure the deceleration of the elevator car.

One embodiment of the means to measure the deceleration of the elevator car can be an inertia wheel attached to traction sheave or other moving components, e.g. diverter pulley or OSG pulley. The torque needed to decelerate the inertia wheel depends on elevator deceleration, and this torque can be converted to measurable spring displacement.

When the deceleration is sensed and/or transformed to feedback with the means to measure the deceleration of the elevator car, brake torque should be adjusted based on the feedback from the means for measuring elevator deceleration.

The brake adjusting or opening force can be transmitted to the brake mechanically or hydraulically. The brake may be opened proportionally or in one or more steps.

In one embodiment the brake adjusting or opening force can be taken, e.g. directly, from the same spring that is used in the means to measure the deceleration of the elevator car. In one embodiment of the invention, force taken from rope termination support spring or diverter pulley support spring can be large enough for opening the brake.

In one embodiment the brake adjusting or opening force can be created with separate hydraulic system and controlled by feedback spring movement and hydraulic valves, e.g. proportional valve or directional control valve. This system requires hydraulic pump, which can be driven with a separate motor or elevator machine. In one embodiment of the invention the proportional valve can be controlled based on the output of a force sensor.

The elevator car deceleration is kept essentially constant at a predefined set point value or within a certain range around the predefined set point value.

Deceleration should be set to a safe value. In addition, the setpoint should be chosen so that elevator normal operation is not disturbed.

The deceleration setpoint value, P-term of the proportional controller, and/or response time of the controller can be dependent on at least one of the following parameters: inertial mass, spring stiffness, rope termination or diverter pulley mass, piston areas (e.g. hydraulic brake adjustment or opening), dimensions of the levers (e.g. mechanical brake adjustment or opening), possible damper that is added to stabilize the controller, clearances, hydraulic valve properties. P-term of the proportional controller is proportional to the value of the difference between the desired setpoint and current measured process variable. For example, if the difference is large and positive, the control output will be proportionately large and positive. In the solution of the invention P-term can be for example proportion of displacement converted into adjustment.

The brake system of the invention can be designed to work in one or both driving directions (car up, car down). If it works in both driving directions, the deceleration setpoint can be the same or different in different directions.

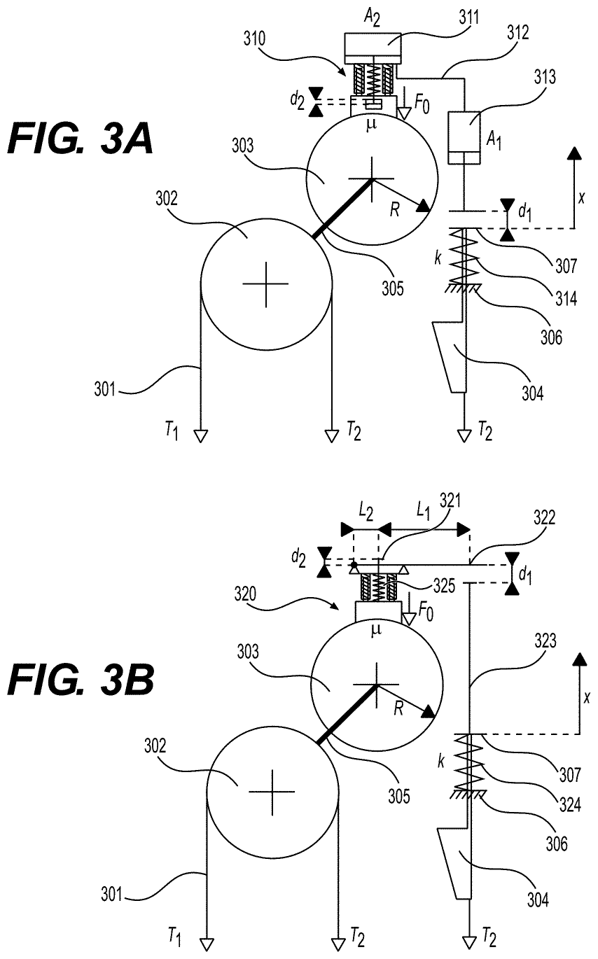

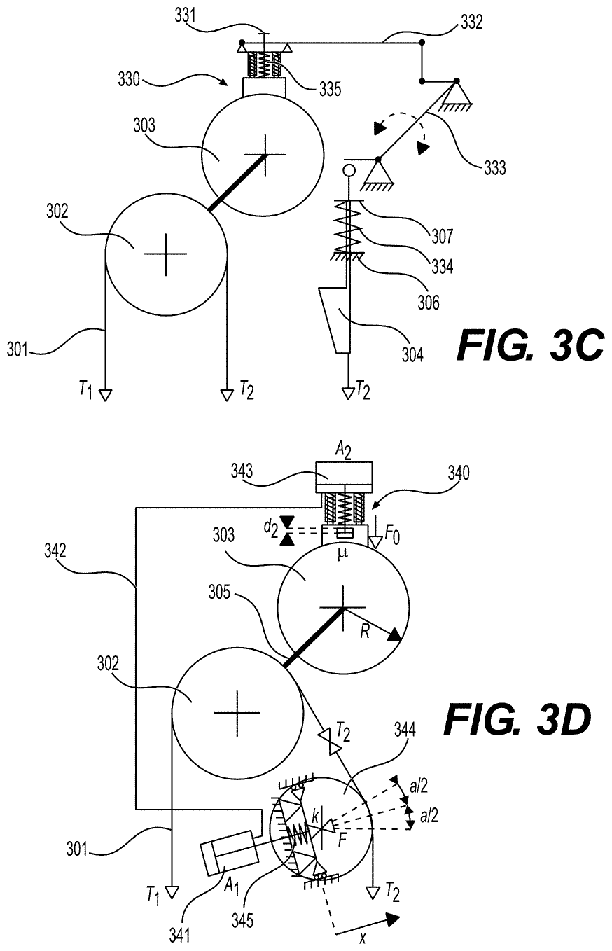

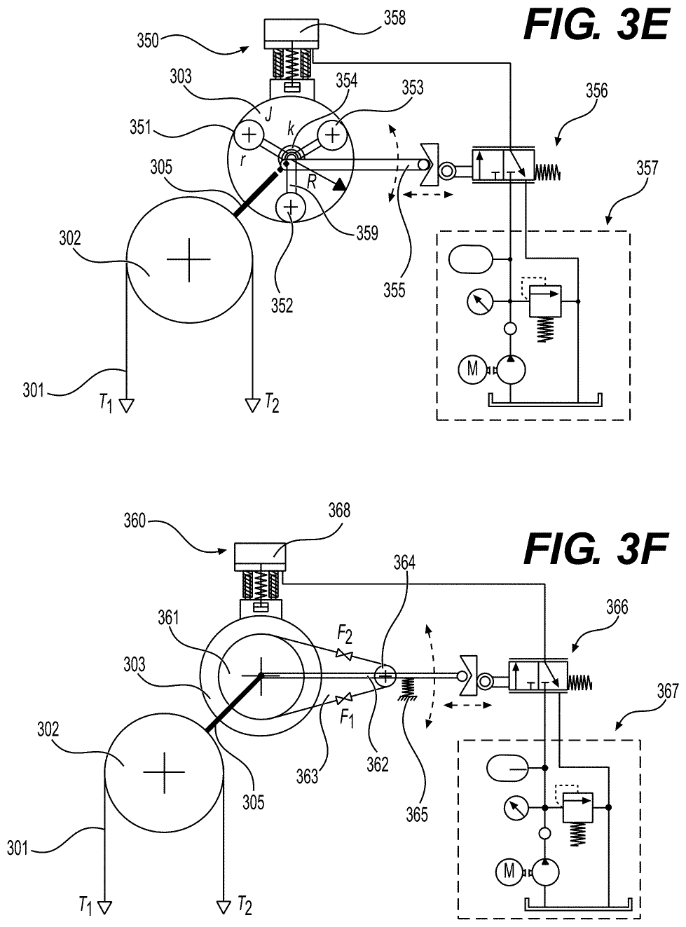

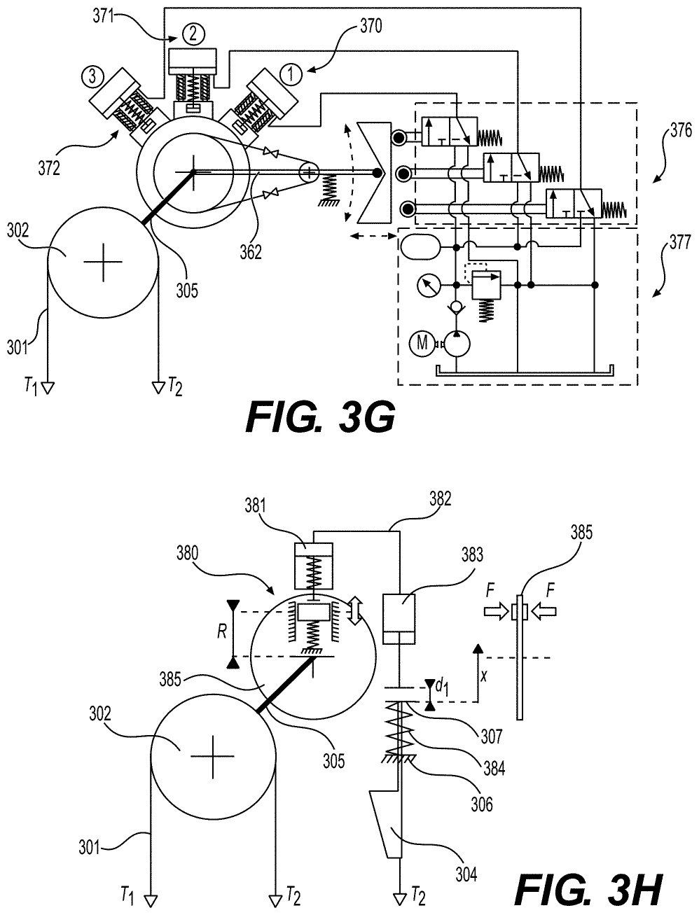

FIGS. 3A-3H present different kind of example embodiments of the brake system of the invention.

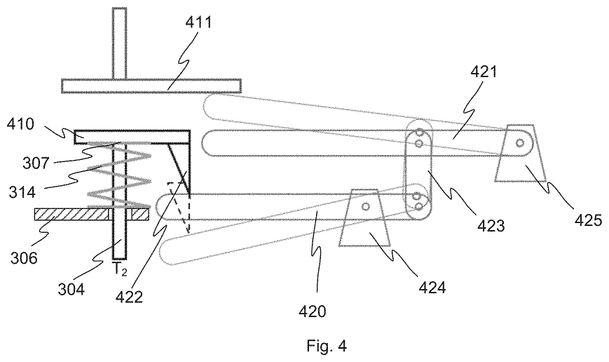

FIG. 3A presents one example embodiment of a brake system of the invention. The example of FIG. 3A comprises a traction sheave 302 connected with a shaft 305 to brake wheel 303 having radius R and coefficient of friction μ. The embodiment also comprises hoisting ropes 301 arranged to travel via the traction sheave. In this example means for measuring elevator deceleration comprise a spring 314 arranged to support rope termination 304. Rope termination 304 can comprise a wedge in which the rope can be attached, an arm and, attached to the arm, spring cup 307 with which the rope termination rests on supporting spring 314. The embodiment also comprises a support structure 306 for supporting the spring 314. The support structure 306 can be attached to the shaft wall or fixed shaft structure in a fixed manner. The support structure 306 can be arranged around the rope termination 304 or it can comprise an opening for rope termination, e.g. the arm of the rope termination, arranged so that the rope termination 304 can move up and down without touching the support structure 306. Corresponding support structure 306 for supporting the spring 314 and/or rope termination 304 can be used also in other embodiments of the invention, e.g. in an embodiment presented in FIG. 3B, in an embodiment presented in FIG. 3C, in an embodiment presented in FIG. 3H, and/or in an embodiment presented in FIG. 4.

In the embodiment presented in FIG. 3A, upon elevator deceleration, the rope tension will change resulting in a vertical displacement of the rope termination 304 and spring 314 supporting it. This displacement x of one end of the spring 314 and rope termination 304 is then transferred to the brakes 310 via a hydraulic system, comprising cylinders 311, 313 at the brake and in connection with the spring and hydraulic fluid line 312 between the cylinders to decrease the force pressing the brake pads against the brake wheel 303. The example of FIG. 3A operates thus so that when deceleration exceeds the predefined set point deceleration value, a displacement x is caused to spring arranged to the rope termination 304 and that displacement x is used by causing a displacement in connection with the brakes via a hydraulic system for adjusting the force pressing the brake against the brake wheel 303 so that the brake torque of the brakes decreases. A clearance d₁ is arranged between the rope termination 304 and cylinder 313 so that only deceleration above certain threshold value, e.g. above the predefined set point value, causes the arrangement to decrease the brake torque. A clearance d₂ is arranged in connection with the brake and the cylinder 311 the so that only deceleration above certain threshold value, e.g. above the predefined set point value, causes the arrangement to decrease the brake torque. Clearance d₂ is also arranged so that the normal movement of the brakes does not cause movement to the cylinders of the hydraulic system.

In one embodiment the solution of FIG. 3A can be arranged to work only in one direction, i.e. to limit the deceleration of the descending car (ascending counterweight). In one embodiment an additional fluid tank can be arranged next to the cylinder arranged in connection with the rope termination so that the cylinder in connection with the brake relieves the brake as the rope termination side cylinder moves away from the centre position. In one embodiment there can be separate hydraulic circuits for ascending elevator car brake force adjustment and descending elevator car brake force adjustment. In this case the system would operate for two directions, i.e. to also limit the deceleration of the ascending car (descending counterweight).

FIG. 3B presents an embodiment which is otherwise similar solution as FIG. 3A, but in this embodiment the displacement x of one end of the spring 324 and rope termination 304 is not transferred to the brakes 320 to decrease the brake torque via a hydraulic system but via a push rod 323 and a lever 322. The example of FIG. 3B operates thus so that when deceleration of a descending car exceeds the predefined set point deceleration value, a displacement x caused to the rope termination 304 and spring 324 supporting it is used for decreasing the brake torque of the brakes via the lever 322 being lifted, raising a pull rod 321 between its support points, which then lightens the spring 325 that loads the brake 320, pressing it against the brake wheel 303. A clearance d₁ is arranged between the push rod 323 and lever 322 so that deceleration above only certain threshold value, e.g. above the predefined set point value, causes the arrangement to decrease the brake torque. Clearance d₂ allows unhindered brake activation. The dimensions L₁ and L₂ of the lever 322 can be arranged so that a desired deceleration is achieved.

In one embodiment the solution of FIG. 3B is arranged to work only in one direction, e.g. for a descending car. The solution presented in FIG. 3B can be also configured so that the system would operate for two displacement directions, i.e. to also limit the deceleration of the ascending car (descending counterweight). An example of this kind of solution is presented in FIG. 4.

FIG. 3C presents an embodiment which is otherwise similar solution as FIG. 3B, but in this embodiment the displacement of rope termination 304 and spring 334 supporting it is not transferred via a push rod and lever but by a torsion bar 333 which is arranged to turn around its axis in response to the displacement. The example of FIG. 3C operates thus so that when deceleration of a descending car exceeds the predefined set point deceleration value, a displacement is caused to rope termination 304 and spring 334 supporting it and that displacement is used for turning the rod 333 and then this rotational force is transferred and converted to a force lifting the lever 332 which raises a pull rod 331 between its support points lightening then the spring 335 that loads the brake 330.

In one embodiment the solution of FIG. 3C is arranged to work only in one direction, e.g. descending car. The solution presented in FIG. 3C can be also configured so that the system would operate for two displacement directions, i.e. to also limit the deceleration of the ascending car (descending counterweight). An example of this kind of solution is presented in FIG. 4.

FIG. 3D presents an embodiment which is otherwise similar solution as FIG. 3A, but in this embodiment the means for measuring elevator deceleration do not comprise a spring arranged to support rope termination 304 but it comprises a diverter pulley 344 which is allowed to be displaced in such a way that during normal elevator operation the pulley 344 is in the first position, resting against a fixed support and is loaded by a diverter pulley support spring 345. If rope force T₂ changes more than a predefined threshold value in response to deceleration of a descending car, a displacement x is caused to the pulley by support spring 345 from the first position, the displacement being proportional to the rope force change. The angle α is the wrap angle of the diverter pulley 344 and the diverter pulley is arranged to move to the direction of the middle of the wrap angle presented in FIG. 3D (and to same direction as x indicates). The diverter pulley 344 can be arranged e.g. in connection to the counterweight side ropes. The displacement of the pulley 344 is then transferred to the brakes 340 and converted to brake torque adjustment via a hydraulic system, comprising cylinders 341, 343 at the brake and in connection with the spring and hydraulic fluid line 342 between the cylinders. The example of FIG. 3D operates thus so that when deceleration exceeds the predefined set point deceleration value, a displacement is caused to the diverter pulley 343 and that displacement is used for adjusting the brake torque by decreasing the force pressing the brake against the brake wheel 303 the same way as in the example of FIG. 3A. A clearance d₂ is arranged in connection with the brake and the cylinder 343 the so that only deceleration above certain threshold value, e.g. above the predefined set point value, causes the arrangement to decrease the brake torque. Clearance d₂ is also arranged so that the normal movement of the brakes does not cause movement to the cylinders of the hydraulic system.

In one embodiment the solution of FIG. 3D is arranged to work only in one direction, e.g. descending car. The solution presented in FIG. 3D can be also configured so that displacement to any direction (e.g. towards the cylinder 341 and away from the cylinder 341) from the centre point of diverter pulley can be arranged to adjust the brake force by decreasing the brake torque of the brakes. In this case the arrangement is able to adjust brake force of an ascending and descending elevator car.

FIG. 3E presents an embodiment in which a proportional valve is arranged to adjust hydraulic pressure from a hydraulic power unit for adjusting brake force. In this example there are rotating masses 351, 352, 353 in contact with the rim of brake wheel 303. The contact is a frictional contact or a shape-locked contact, e.g. toothing. The masses 351, 352, 353 can be rotatably attached to a carrier 359 that is pivotably mounted on the same shaft as brake wheel 303 and stabilized by a spring 354, such as a torsion spring. A rod 355 is coupled with carrier 359 and articulated to the same shaft with the carrier 359, which rod 355 transmits the displacement of spring 354 and carrier 359 to the proportional valve. For a descending elevator car decelerating, the inertia of masses 351, 352, 353 tend to continue rotating, causing carrier 359 to turn and turn the rod 355. The greater the deceleration is, bigger is the movement of carrier 359 and rod 355. If the movement of the rod 355 is large enough, it opens a proportional valve 356 that releases hydraulic pressure, created e.g. by a hydraulic system 357, to the brake release cylinder 358. In this case, the braking torque and the deceleration of the elevator are reduced. The inertial system of FIG. 3E is mounted on the same shaft 305 as the traction sheave 302. The embodiment of the FIG. 3E can operate on limiting the deceleration when the elevator car is ascending and when it is descending.

FIG. 3F presents an embodiment which comprises one brake 360, a belt pulley 361, an inertia wheel 364 and a proportional valve 366 arranged to adjust hydraulic pressure created e.g. by a hydraulic system or unit 367. In this embodiment the belt pulley 361, is rotated by a traction sheave 301 or other wheel. The belt pulley rotates the inertia wheel 364 via a belt 363. The inertia wheel 364, i.e. a rotating mass, is mounted on an arm 362, a first end of which is pivotably mounted at or near the belt pulley 361 axle 305. The arm 362 can be centred e.g. with a spring 365. When the elevator is not moving or is moving at constant speed, belt forces F₁ and F₂ are essentially equal. For a descending elevator car decelerating, the mass of the inertia wheel 364 tends to continue rotating, causing the belt forces to change (F₁>F₂) and the arm 362 to turn downwards. The greater the deceleration is, the bigger is also the displacement of the arm 362 and spring 365. If the movement of the arm 362 is large enough, it opens a proportional valve 366 that releases hydraulic pressure to the brake release cylinder 368, reducing the brake torque and, hence, the deceleration of the elevator. The embodiment of the FIG. 3F can operate on limiting the deceleration when the elevator car is ascending and when it is descending.

FIG. 3G presents an embodiment which is otherwise similar solution as FIG. 3F but it comprises three separate brakes 370, 371, 372. Also the feedback of the means to sense deceleration or inertial force and to create feedback is then distributed to several hydraulic control valves, e.g. on-off control valves, 376 or daisy-chained to several control valves (in this example three control valves) based on the magnitude of the inertia force. These control valves then control the separate brakes (in this example three). In the example of FIG. 3G, if the movement of the arm 362 is large enough, it opens at first the first directional control valve that releases hydraulic pressure created e.g. by a hydraulic system or unit 377, to the first brake release cylinder, then with the higher deceleration the second directional control valve that releases hydraulic pressure to the second brake release cylinder and then finally with even higher deceleration, the third directional control valve that releases hydraulic pressure to the third brake release cylinder.

FIG. 3H presents one example embodiment of a brake system of the invention. The example of FIG. 3H comprises a traction sheave 302 connected with a shaft 305 to brake wheel 385. A cross section view of the brake wheel 385 is presented on the right part of FIG. 3H. The embodiment also comprises hoisting ropes 301 arranged to travel via the traction sheave. In this example means for measuring elevator deceleration comprise a spring 384 arranged to support rope termination 304. Upon elevator deceleration, the rope tension will change resulting in a vertical displacement of the rope termination 304 and spring 384 supporting it. This displacement x of rope termination is then transferred to the brakes 380 via a hydraulic system, comprising cylinders 381, 383 at the brake and in connection with the spring and hydraulic fluid line 382 between the cylinders. In this embodiment the radius R by which the brake pads act on the brake wheel 385 is changed according to the deceleration. In this embodiment the force F by which the brake pads are pressed against the brake wheel 385 does not change, but the radius R changes, which also changes the brake torque M (M=FR). A clearance d₁ is arranged between the spring 384 and cylinder 383 so that only deceleration above certain threshold value, e.g. above the predefined set point value, causes the arrangement to decrease the brake torque.

FIG. 4 illustrates a part of the brake system according to one example embodiment of the invention. The solution presented in FIG. 4 can be used e.g. with the embodiments presented in FIGS. 3B and 3C so that a big enough vertical displacement, up or down, of the rope termination and the spring supporting it from the position corresponding to rope tension during elevator standstill can be arranged to decrease the brake torque. The solution illustrated in FIG. 4 comprises bars 420 and 421 which are arranged in operative connection with rope termination 304 supported by spring 314. This embodiment comprises essentially corresponding support structure 306 for supporting the spring 314 as the embodiment of FIG. 3A. The first bar 420 and the second bar 421 are configured such that in the case when the rope termination moves down, this pushes the first bar 420 and the arrangement thereby moves the second bar 421 to cause a displacement for directing a torque adjustment to brakes. The arrangement may comprise a third bar 423 for guiding the force from the first bar 420 to the second bar 421 and/or attachment points for the first bar 424 and the second bar 425 arranged such that the force from the first bar 420 is directed to the second bar 421 so that downward movement of the rope termination causes adjustment of the brakes. There may be parts 410, 422, 411 arranged to direct the force toward the first bar 420 and direct the force toward the brake via the second bar 421. With the example arrangement of FIG. 4 the brake system is thus able to decrease brake force of also an ascending elevator car. In the case of descending car, the displacement is directed to the brakes without the first bar 420 and the second bar 421 but as described in connection with FIGS. 3B and 3C.

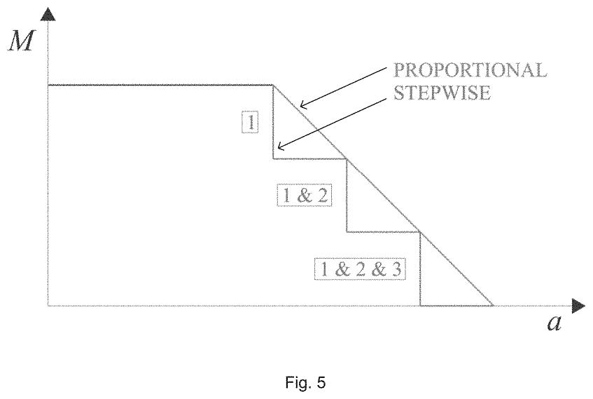

In one embodiment the brake system is configured to reduce brake torque if the measured deceleration is above the predefined set point value until the deceleration has settled to the predefined set point value and to increase brake torque (i.e. decrease reducing the brake torque) if the measured deceleration is below the predefined set point value until the deceleration has settled to the predefined set point value, wherein the brake system is configured to adjust, e.g. decrease, the brake torque proportionally or in one or more steps. This is presented in FIG. 5 which presents an example of these two different kind of adjustments. The example of FIG. 5 can be used e.g. with the solution of FIG. 3G, in which there are three separate brakes. If the brakes 1-3 are released in three steps the braking torque decreases every time when the braking torque created by a single brake is released.

In one embodiment of the invention the braking system is configured such that, despite the adjustment of the braking torque or force, the elevator car or counterweight must not hit the buffer at overspeed. Thus, at the ends of the elevator shaft, it may be necessary to decelerate at full force despite the fact that the deceleration becomes large, as this is a better option than driving the overspeed to the buffer. In one embodiment of the invention, full deceleration and brake torque is used at certain parts of the elevator shaft, e.g. within a certain distance from the end of the shaft.

In one embodiment of the invention, brake torque is adjusted, e.g. decreased, only for a certain time according to the solution or the invention, e.g. 2-6 seconds, and after that time full brake force and/or torque is used. This prevents the braking of the elevator car taking too long distance.

What has been said above in connection with the machine brake and brake torque is directly applicable by a person skilled in the art to the brake acting on the guide of the elevator car and the braking force produced by it.

The embodiments of FIGS. 3E, 3F and 3G present the use of inertial force in connection with the brake wheel 303 but the principle can be used also in connection with any pulley of the elevator which is rotated by hoisting ropes.

In one embodiment in which coated ropes are used the elevator car deceleration set point value or the range around the predefined set point value is selected or determined such that the slipping of the coated ropes can be avoided. By avoiding slipping of the ropes, it's possible to better predict the friction between the ropes and the traction sheave, especially in the case of coated ropes. Thus, the elevator system can be dimensioned more reliably when there is no slipping between the ropes and traction sheave during braking. The deceleration can be limited e.g. in such a way that the friction factor demand between the ropes and the traction sheave does not increase to such an extent that the ropes begin to slip significantly on the traction sheave. The friction factor (f) can be determined or calculated in one example embodiment from the rope force ratio (T1/T2 ratio) and angle or wrap of the ropes on the traction sheave (α) using the Eytelwein formula: T₁/T₂≤e^{fα}.

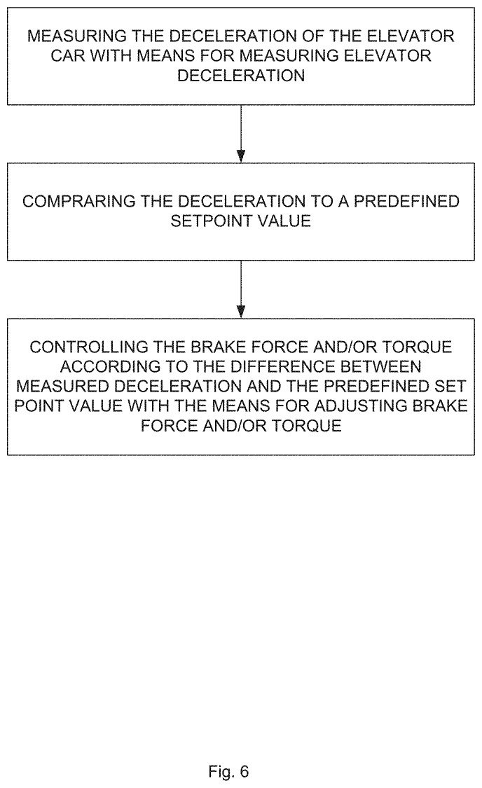

FIG. 6 presents one example embodiment of the method according to the solution of the present invention. In this embodiment, in the first step the deceleration of the elevator car is measured with means for measuring elevator deceleration. In the second step the deceleration is compared to a predefined set point value. In the third step the brake force or torque is controlled according to the difference between measured deceleration and the predefined set point value with the means for adjusting brake force or torque.

A controller of an elevator system which can be used in one embodiment of the invention to control for example the motor moving the elevator or other elevator components may comprise at least one processor connected to at least one memory. The at least one memory may comprise at least one computer program which, when executed by the processor or processors, causes the controller to perform the programmed functionality. In another embodiment, the at least one memory may be an internal memory of the at least one processor. The controller may also comprise an input/output interface. Via the input/output interface, the control apparatus may be connected to at least one wireless device. The controller may be a control entity configured to implement only the above disclosed operating features, or it may be part of a larger elevator control entity, for example, an elevator controller or an elevator group controller.

As stated above, the components or other parts of the exemplary embodiments can include computer readable medium or memories for holding instructions programmed according to the teachings of the present embodiments and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD1RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge or any other suitable medium from which a computer can read. The embodiments of the invention described hereinbefore in association with the figures presented and the summary of the invention may be used in any combination with each other. At least two of the embodiments may be combined together to form a further embodiment of the invention.

The specific examples provided in the description given above should not be construed as limiting the applicability and/or the interpretation of the appended claims. Lists and groups of examples provided in the description given above are not exhaustive unless otherwise explicitly stated.

1. A brake system for elevators, the elevator comprising an elevator car and suspension means supporting the elevator car and the counterweight, wherein the brake system comprises:
at least one brake configured to decelerate the elevator car,
means for measuring elevator deceleration configured to produce feedback, such as a displacement, relating to elevator deceleration to the at least one brake,
means for adjusting brake force and/or torque based on the feedback from the means for measuring elevator deceleration,
wherein the means for adjusting brake force and/or torque is configured to control the brakes to produce a variable brake force and/or torque so that the elevator car deceleration is kept essentially constant at a predefined set point value or within a certain range around the predefined set point value.

2. A brake system according to claim 1, wherein the means for adjusting brake force and/or torque is a mechanical and/or hydraulic controller configured to control the brakes of the brake system, e.g. a proportional controller.

3. A brake system according to claim 1, wherein means for measuring elevator deceleration is configured to measure the deceleration based on inertial force caused by an inertial mass, wherein the inertial mass is connected to moving components of the elevator so that the inertial force is proportional to elevator deceleration, and wherein the inertial force is configured to be converted to a displacement and the displacement corresponds with the elevator deceleration or the inertial force is configured to be converted directly to feedback with a force sensor.

4. A brake system according to claim 1, wherein means for measuring elevator deceleration is configured to measure deceleration from hoisting rope termination support spring displacement caused by one or more rope forces on the rope termination on the counterweight side of the sheave.

5. A brake system according to claim 1, wherein means for measuring elevator deceleration comprises a diverter pulley which is allowed to be displaced in such a way that during normal elevator operation the pulley is in the first position/the pulley rests on a fixed support but if rope force changes more than a predefined threshold value, a displacement is caused to the diverter pulley from the first position that is proportional to rope force, the diverter pulley being arranged e.g. in connection to the hoisting ropes on the counterweight side of the sheave.

6. A brake system according to claim 1, wherein the means for measuring elevator deceleration comprise an inertia wheel operatively coupled with a moving component of the elevator, such as a traction sheave, and wherein feedback relating to elevator deceleration is the inertia of the inertia wheel, and the means for measuring elevator deceleration is configured such that the inertia is converted to measurable spring displacement.

7. A brake system according to claim 1, wherein a force for adjusting the brake force and/or torque is transmitted to the brake mechanically based on the displacement, and/or
wherein the force for adjusting the brake force and/or torque is configured to be taken from the spring that is used in the means for measuring elevator deceleration, e.g. from rope termination support spring or diverter pulley support spring.

8. A brake system according to claim 1, wherein a force for adjusting the brake force and/or torque is transmitted to the brake hydraulically based on the displacement, and/or
wherein the force for adjusting the brake force and/or torque is configured to be created with a hydraulic system and controlled by spring movement and hydraulic valves and/or hydraulic cylinders.

9. A brake system according to claim 1, wherein the predefined deceleration setpoint value, P-term of the proportional controller and/or response time of the controller are dependent on at least one of the following parameters: inertial mass, spring stiffness, rope termination or diverter pulley mass, piston areas, dimensions of the levers, presence of a damper configured to stabilize the controller, clearances, hydraulic valve properties.

10. A brake system according to claim 1, wherein the brake system is essentially or fully mechanical and/or hydraulic.

11. A brake system according to claim 1, wherein the suspension means are high friction suspension means such as toothed belts, ropes or belts comprising polymer coating, e.g. TPU, and/or ropes or belts comprising high friction lubricants.

12. A brake system according to claim 1, wherein the brake is a machinery brake or a car brake of the elevator.

13. A method for braking an elevator with a brake system, the elevator comprising an elevator car and suspension means supporting the elevator car and the counterweight,
wherein the brake system comprises at least one brake configured to decelerate the elevator car, means for measuring elevator deceleration configured to produce feedback, such as a displacement, relating to elevator deceleration to the at least one brake, and means for adjusting brake force and/or torque based on the feedback from the means for measuring elevator deceleration,
wherein in the method:
the deceleration of the elevator car is measured with means for measuring elevator deceleration,
the deceleration is compared to a predefined setpoint value, and
brake force and/or torque is controlled according to the difference between measured deceleration and the predefined set point value with the means for adjusting brake force and/or torque.

14. A method according to claim 13, wherein means for measuring elevator deceleration measures the deceleration based on inertial force caused by an inertial mass, wherein the inertial mass is connected to moving components of the elevator so that the inertial force is proportional to elevator deceleration, and wherein the inertial force is converted to a displacement and the displacement corresponds with the elevator deceleration or the inertial force is converted directly to feedback with a force sensor.

15. An elevator comprising
an elevator car,
an elevator motor configured to move the elevator car, and
a brake system according to claim 1.

16. A computer program comprising instructions which, when executed by a computer, cause the computer to carry out the method according to claim 13.

17. A computer-readable medium comprising the computer program according to claim 16.
